(19) United States
(12) Patent Application Publication
(10) Pub. No.: US 2023/0367860 A1
(43) Pub. Date: Nov. 16, 2023

(54) INSTRUCTION VERIFICATIONS

(71) Applicant: Hewlett-Packard Development Company, L.P., Spring, TX (US)

(72) Inventor: Christopher H. Stewart, Spring, TX (US)

(21) Appl. No.: 17/745,593

(22) Filed: May 16, 2022

(51) Int. Cl. G06F 21/33; G06F 21/64; G06F 21/57

(52) U.S. Cl. CPC G06F 21/33; G06F 21/64; G06F 21/572

(57) ABSTRACT

Examples of electronic devices are described herein. In some examples, an electronic device includes an operating system (OS). In some examples, the electronic device includes a basic input/output system (BIOS). In some examples, the electronic device includes an OS certificate store. In some examples, the electronic device includes a processor to load a certificate from the BIOS. In some examples, the OS certificate store is bypassed during the loading of the certificate. In some examples, the processor is to execute a program in the OS to verify signed instructions based on the certificate.

### BACKGROUND

A certificate is data that identifies an entity (e.g., certificate issuer, certificate authority (CA), another certificate, root certificate, etc.). For instance, a certificate may be a file referred to as a digital certificate. In some examples, a certificate may include information indicating the identity of an entity, a public key, a signature, or a combination thereof.

### BRIEF DESCRIPTION OF THE DRAWINGS

FIG. 1 is a thread diagram illustrating an example of instruction verification in accordance with some examples of the techniques described herein;

FIG. 2 is a block diagram illustrating an example of an electronic device that may be used to perform instruction verification;

FIG. 3 is a block diagram illustrating an example of a computing device to perform instruction verifications;

FIG. 4 is a block diagram illustrating an example of a computer-readable medium for instruction verification; and

FIG. 5 is a flow diagram illustrating an example of a method for instruction verification.

### DETAILED DESCRIPTION

In some examples, an electronic device (e.g., computing device) may classify a certificate or content with a certificate as trusted or untrusted. For instance, an executable image signed by a trusted issuer may be allowed to be executed, installed, or a combination thereof by an electronic device.

An electronic device may include a certificate store or certificate stores. A certificate store is a repository of a certificate(s) from a trusted certificate authority or authorities. For instance, an operating system (OS) installed on an electronic device may include an OS certificate store or stores. In some examples, any signature that has been created by a certificate not issued by one of the trusted certificate authorities may be de facto untrusted. For instance, signed malware that is not issued by a trusted certificate authority may be blocked from installation or execution by a computer.

In some examples, it may be useful to evaluate trust for an additional certificate authority or authorities for a different environment (e.g., an environment different from the local OS environment). However, adding a certificate(s) to the OS certificate store(s) may change a trust model for an organization, computer, service, user, or a combination thereof. For instance, adding a new certificate to an OS certificate store may increase a security risk because signed instructions corresponding to the added certificate(s) may be allowed to be installed, executed, or a combination thereof beyond a target context. For instance, adding a new certificate to an OS certificate store may implicitly extend the trust of the certificate to a broader scope than is targeted for a specific operation. Accordingly, adding a certificate(s) to an OS certificate store for evaluation may increase security risk by broadening a scope of trust of an OS to include a certificate authority for a different environment.

Some examples of the techniques described herein may enable evaluating the trust of a certificate that is not included in the OS certificate store(s) within a limited context. A certificate that is not included in the OS certificate store(s) may be referred to as a foreign certificate. Some examples of the techniques described herein may allow an application to incorporate trust of a foreign certificate(s) for a signature verification session (e.g., for a single signature verification session). For instance, the application may integrate trust of a foreign certificate into a single verification session, thereby allowing the application to simulate the trust of the foreign entity to which that trust applies. For example, an OS application may add a firmware certificate to a trust model for a single signature verification session without modifying the OS certificate store(s) (e.g., without modifying any policies for that application or the service, user, computer, or organization to which the application belongs). In some examples, a foreign certificate(s) may be trusted for a single session, after which the foreign certificate(s) may become untrusted. For instance, some examples of the techniques described herein may temporarily extend a signature verification trust model extant in an OS certificate store(s) that are specific to a user, service, computer, or organization, without modifying the OS certificate store(s) (e.g., without modifying any long-term trust model for that user, service, computer, or organization).

As used herein, a public key is a cryptographic value (e.g., number, string of characters, etc.) that may be publicly available. In some examples, a public key and a private key may be generated using an asymmetric cryptography technique (e.g., public-key cryptography). A private key is a cryptographic value (e.g., number, string of characters, etc.) to be kept secret or confidential to an entity.

A signature is a value (e.g., string of characters, number, etc.) produced using a private key. For instance, a trusted entity may utilize a signing technique (e.g., signing program) to produce a signature based on content (e.g., certificate content, an executable image, a file, a hash, etc.) and a private key. For example, content may be encrypted using the private key to produce the signature. In some examples, an entity may produce a signature using content of a certificate and a private key. The signature may be appended to the certificate.

In some examples, a signature may be verified by decrypting the signature using a public key. In some examples, a signature may be decrypted using a public key, and the decrypted content may be compared with the original content to verify the authenticity of the content. For instance, the signature of a certificate may be decrypted using the public key of the certificate, and the decrypted content (e.g., a decrypted hash) may be compared with the original content (e.g., a hash of the original content) of the certificate. As used herein, integrity verification may refer to a procedure where content is verified using a public key included with the content or associated with the content. As used herein, issuer verification may refer to a procedure where content is verified using a public key from another certificate (e.g., signing certificate, intermediate certificate, root certificate, etc.) of an issuer that may have (e.g., purportedly has) signed the content.

In some examples, a certificate may indicate a supported hashing technique (e.g., SHA-1, SHA-2, SHA-256, SHA-384, SHA-512, another hashing technique, etc.). The supported hashing technique may be utilized to generate a hash to perform integrity verification, issuer verification, or a combination thereof. Some examples of the certificates described herein may be X.509 certificates.

Throughout the drawings, similar reference numbers may designate similar or identical elements. When an element is referred to without a reference number, this may refer to the element generally, without limitation to any particular drawing or figure. In some examples, the drawings are not to scale, and the size of some parts may be exaggerated to more clearly illustrate the example shown. Moreover, the drawings provide examples in accordance with the description. The description is not limited to the examples provided in the drawings.

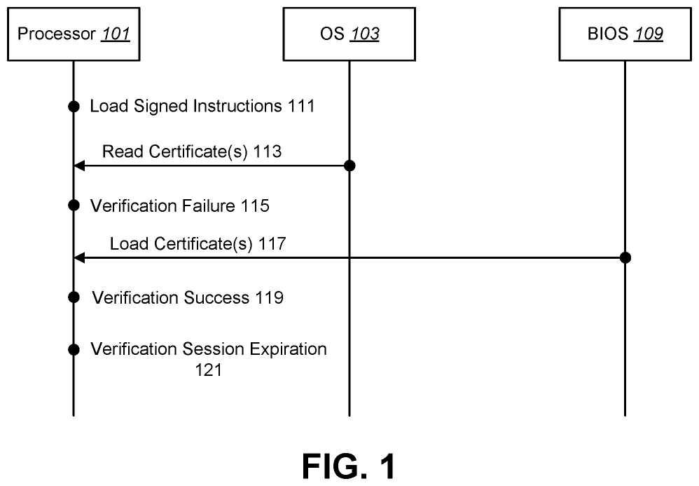

FIG. 1 is a thread diagram illustrating an example of instruction verification in accordance with some examples of the techniques described herein. FIG. 1 illustrates examples of a processor 101, an OS 103, and a basic input/output system (BIOS) 109. In some examples, the processor 101, OS 103, and BIOS 109 may be components of an apparatus, electronic device (e.g., electronic device 202), or computing device (e.g., computing device 338).

An electronic device is a device that includes electronic circuitry (e.g., integrated circuitry). A computing device is an electronic device that includes a processor, logic circuitry, or a combination thereof. Examples of computing devices may include desktop computers, laptop computers, tablet devices, smartphones, televisions, game consoles, smart speakers, voice assistants, Internet of Things (IoT) devices, etc. A computing device may utilize processor(s) or logic circuitry to perform an operation or operations. In some examples, computing devices may execute instructions stored in memory to perform the operation(s). Instructions may be code or programming that specifies functionality or an operation of a processor or logic circuitry.

In some examples, data (e.g., information, instructions, or a combination thereof) may be stored in memory (e.g., volatile memory, non-volatile memory, or a combination thereof). Examples of memory may include Random Access Memory (RAM), Read-Only Memory (ROM), Erasable Programmable ROM (EPROM), Electrically Erasable Programmable ROM (EEPROM), flash memory, etc.), a storage device, an optical disc, the like, or a combination thereof. For instance, data may be stored in volatile or non-volatile memory, such as Dynamic Random Access Memory (DRAM), embedded MultiMediaCard (eMMC), magnetoresistive random-access memory (MRAM), phase change RAM (PCRAM), Synchronous Dynamic Random Access Memory (SDRAM), Double Data Rate (DDR) RAM, memristor, the like, or a combination thereof. In some examples, different memories (e.g., flash memories) in an electronic device may store separate data for same or different circuitries. For instance, instructions may be stored in Serial Peripheral Interface (SPI) flash memory, instructions may be stored in eMMC memory, or a combination thereof, etc. In some examples, memory may refer to a non-transitory tangible machine-readable storage medium, where the term “non-transitory” does not encompass transitory propagating signals.

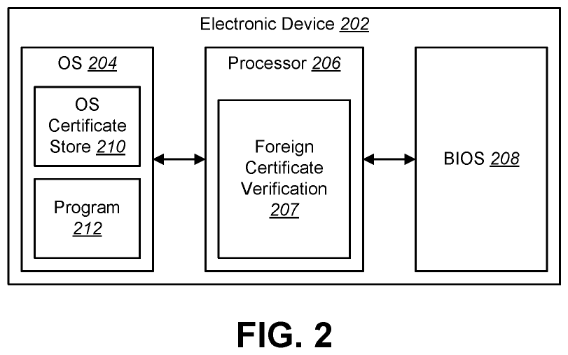

In some examples, the processor 101, the OS 103, and the BIOS 109 may be respective examples of the processor 206, OS 204, and the BIOS 208 described in FIG. 2. In some examples, portions of the electronic device 202 may be coupled via an interface (e.g., bus(es), wire(s), connector(s), etc.). As used herein, the term “couple” or “coupled” may denote a direct connection (without an intervening component) or an indirect connection (with an intervening component(s)). In some examples, the processor 101 may be coupled to the OS 103 and to the BIOS 109 via a bus (e.g., SPI bus).

As used herein, a BIOS refers to hardware or hardware and instructions to initialize, control, or operate a device (e.g., computing device 338, electronic device 202, etc.) prior to execution of an OS of the device. Instructions included within a BIOS may be software, firmware, microcode, or other programming that defines or controls functionality or operation of a BIOS. In one example, a BIOS may be implemented using instructions, such as platform firmware of a device, executable by a processor. In some examples, the processor 101 may execute BIOS instructions to perform an operation or operations described herein. In some examples, BIOS instructions may be stored in a memory (e.g., flash memory, ROM, etc.) and executed by the processor 101 to perform a BIOS operation. A BIOS may operate or execute prior to the execution of an OS of a device. A BIOS may initialize, control, or operate components such as hardware components of a device and may load or boot an OS of a device.

In some examples, a BIOS may provide or establish an interface between hardware devices or platform firmware of the device and an OS of the device, via which the OS of the device may control or operate hardware devices or platform firmware of the device. In some examples, a BIOS may implement the Unified Extensible Firmware Interface (UEFI) specification or another specification or standard for initializing, controlling, or operating a device.

As used herein, an OS refers to hardware or hardware and instructions to control or operate a device (e.g., computing device 338, electronic device 202, etc.). For instance, an OS may operate after a boot procedure performed by a BIOS. Instructions included in an OS may be code, microcode, or other programming that defines or controls functionality or operation of an OS. In one example, an OS may be realized using instructions executable by a processor. In some examples, the processor 101 may execute OS instructions to perform an operation or operations described herein.

In some examples, OS instructions may be stored in an electronic, magnetic, optical, other physical storage device, or a combination thereof. In some examples, OS instructions may be stored in a first memory device with greater storage capacity than a second memory device to store BIOS instructions.

At step 111, the processor 101 loads signed instructions. Signed instructions are instructions accompanied by a signature. For instance, signed instructions may be programmatic instructions, an application, firmware, driver, etc., signed by an entity. In some examples, the signature may be included in a certificate accompanying the signed instructions. The certificate may indicate a public key, an issuer identity, and the signature. In some examples, the processor 101 may load the signed instructions from a storage device, communication interface (e.g., wired interface, wireless interface, Ethernet interface, Institute of Electrical and Electronics Engineers (IEEE) 802.11 (Wi-Fi) interface, Bluetooth interface, etc. In some examples, the signed instructions may be loaded into memory (e.g., RAM).

In some examples, the processor 101 may perform an integrity verification on the signed instructions. For instance, the processor 101 may decrypt the signature using the public key in the certificate of the signed instructions to produce a first integrity hash. The processor 101 may hash contents (e.g., hash the executable instructions of the signed instructions) to produce a second integrity hash. In a case that the first integrity hash and the second integrity hash match, the integrity verification is successful (and operation may proceed for further verification, for instance). In a case that the first integrity hash and the second integrity hash do not match, the integrity verification failed. If the integrity verification failed, the signed instructions may be unverified (e.g., reported as untrusted or unverified), not installed, not executed, or a combination thereof, for instance. In some examples, a verification(s) may be performed using a cryptographic key(s) (e.g., public key, private key, cryptographic key pair(s), etc.) outside of the context of a certificate. For instance, a BIOS may make use of private key and public key pairs outside of a certificate(s).

At step 113, the processor 101 reads a certificate from the OS 103. For instance, the processor 101 may read a certificate or certificates from an OS certificate store or OS certificate stores. In some examples, the processor 101 may read a certificate from the OS certificate store with an issuer identity that matches the issuer identity in a certificate of the signed instructions. In some examples, the processor 101 may determine that no certificate from the OS certificate store has an issuer identity that matches the issuer identity in a certificate of the signed instructions.

The processor 101 may perform a first verification (e.g., issuer verification) on the signed instructions. For example, the processor 101 may perform issuer verification if an issuer identity of a certificate from the OS certificate store matches the issuer identity in the certificate of the signed instructions. For instance, the processor 101 may decrypt the signature using the public key in the certificate with a matching issuer identity from the OS certificate store to produce a first issuer hash. The processor 101 may hash contents (e.g., hash the executable instructions of the signed instructions) to produce a second issuer hash. In a case that the first issuer hash and the second issuer hash match, and the certificate from the OS certificate store is a root certificate, the first verification is successful and the signed instructions may be trusted (e.g., reported as trusted or verified), installed, executed, or a combination thereof. If the first issuer hash and the second issuer hash match and the certificate from the OS certificate store is an intermediate certificate, then issuer verification may be performed recursively for the intermediate certificate (or an additional certificate(s) in a chain of trust) until the issuer verification succeeds with a root certificate or fails.

In some examples, in a case that the first issuer hash and the second issuer hash do not match (or issuer verification fails in recursive issuer verification in the chain of trust, for instance), a first verification failure occurs at step 115. In some examples, in a case that the OS 103 (e.g., OS certificate store) does not include a certificate with an identity corresponding to the identity of the certificate of the signed instructions, a first verification failure. In the example of FIG. 1, a first verification failure occurs at step 115.

In response to the first verification failure, the processor 101 may load a certificate (e.g., a foreign certificate) from the BIOS 109 at step 117. For instance, the processor 101 may load a foreign certificate or certificates from a BIOS certificate store (e.g., BIOS database, dbkeys database, etc.). In some examples, the certificate(s) may be loaded in memory (e.g., RAM, into a signature verification object, etc.). In some examples, the certificate may be loaded from the BIOS 109 without modifying an OS certificate store(s). In some examples, the processor 101 may load a foreign certificate from the BIOS certificate store with an issuer identity that matches the issuer identity in a certificate of the signed instructions. In some examples, the processor 101 may determine that no certificate from the BIOS certificate store has an issuer identity that matches the issuer identity in a certificate of the signed instructions. In some examples, the processor 101 may load a foreign certificate from a device (e.g., external device, external storage, network device, server, etc.).

The processor 101 may perform a second verification on the signed instructions. For example, the processor 101 may perform issuer verification if an issuer identity of a certificate (e.g., foreign certificate) from the BIOS certificate store matches the issuer identity in the certificate of the signed instructions. For instance, the processor 101 may decrypt the signature using the public key in the certificate with a matching issuer identity from the BIOS certificate store to produce a first issuer hash. The processor 101 may hash contents (e.g., hash the executable instructions of the signed instructions) to produce a second issuer hash. In a case that the first issuer hash and the second issuer hash match, and the certificate (e.g., foreign certificate) from the BIOS certificate store is a root certificate, the issuer verification is successful at step 119. In a case of successful issuer verification, the signed instructions may be trusted (e.g., reported as trusted or verified), installed, executed, or a combination thereof. If the first issuer hash and the second issuer hash match and the certificate from the OS certificate store is an intermediate certificate, then issuer verification may be performed recursively for the intermediate certificate (or an additional certificate(s) in a chain of trust) until the issuer verification succeeds with a root certificate or fails.

In some examples, in a case that the first issuer hash and the second issuer hash do not match (or issuer verification fails in recursive issuer verification in the chain of trust, for instance), an issuer verification failure occurs. In some examples, in a case that the BIOS 109 (e.g., BIOS certificate store) does not include a certificate with an identity corresponding to the identity of the certificate of the signed instructions, an issuer verification failure may occur. If the issuer verification failed, the signed instructions may be unverified (e.g., reported as untrusted or unverified), not installed, not executed, or a combination thereof, for instance.

In the example of FIG. 1, verification success occurs at step 119. Accordingly, the signed instructions may be trusted (e.g., reported as trusted or verified), installed, executed, or a combination thereof.

In the example of FIG. 1, a verification session expiration occurs at step 121. A verification session is a period of time in which verification (e.g., integrity verification, issuer verification, or a combination thereof) of signed instructions is performed. In some examples, a verification session may endure while verification is performed (and while verification results are reported, for instance). For instance, once verification is performed, the verification session may expire. In some examples, a verification session may endure while an object instance (e.g., an instance of a verification object where the foreign certificate is loaded) remains in scope. For instance, when an object instance goes out of scope, the verification session may expire. When the verification session expires, the signed instructions may become untrusted if the verification succeeded based on a certificate (e.g., foreign certificate) from the BIOS 109.

FIG. 2 is a block diagram illustrating an example of an electronic device 202 that may be used to perform instruction verification. Examples of the electronic device 202 may include a computer (e.g., desktop computer, laptop computer, etc.), a smartphone, a tablet computer, a game console, etc. The electronic device 202 may include an OS 204, processor 206, and a BIOS 208. In some examples, the processor 206 may include a central processing unit (CPU) (e.g., host CPU). The CPU may be a processor to perform an operation on the electronic device 202. Examples of the CPU may include a general-purpose processor, a microprocessor, etc. In some examples, the CPU may be an application processor. In some examples, the CPU may execute instructions (e.g., a program, verification program, etc.) on the electronic device 202.

In some examples, the electronic device 202 may include a first memory (not shown in FIG. 2) to store OS instructions. For instance, instructions for the OS 204 may be stored in an electronic, magnetic, optical, other physical storage device, or a combination thereof, that contains or stores electronic data (e.g., information and instructions). In some examples, the first memory may include multiple devices (e.g., a RAM card and a solid state drive (SSD)). In some examples, the OS 204 may include data, instructions for execution by the processor 206, or a combination thereof. In some examples, the first memory may be separate from a second memory (not shown in FIG. 1) to store BIOS instructions. In some examples, the first memory to store OS instructions may have a larger storage capacity than the second memory to store BIOS instructions. In some examples, the first memory may be coupled to a motherboard of the electronic device 202 (via serial advanced technology attachment (SATA), parallel advanced technology attachment (PATA), integrated drive electronics (IDE), non-volatile memory express (NVMe), RAM slot(s), or a combination thereof, for instance).

The processor 206 may be a logic circuit. For instance, the processor 206 may be a logic circuit capable of performing logical operations. Examples of the processor 206 may include a field-programmable gate array (FPGA), application-specific integrated circuit (ASIC), CPU, controller, engine, etc. For instance, the processor 206 may be a CPU or another processor, controller, or engine. In some examples, the processor 206 may be coupled to a processor socket of a motherboard (not shown in FIG. 2) of the electronic device 202. In some examples, the processor 206 may be attached (e.g., soldered) to a motherboard of the electronic device 202.

In some examples, the electronic device 202 may include a second memory (not shown in FIG. 2) to store BIOS instructions. In some examples, the second memory may be non-volatile memory circuitry, EPROM, EEPROM, flash memory, or a combination thereof. For example, BIOS instructions may be stored in NAND flash memory or NOR flash memory. In some examples, the second memory may be attached (e.g., soldered) to a motherboard of the electronic device 202. In some examples, the BIOS 208 may include firmware (e.g., firmware executable by the processor 206 to boot the electronic device 202).

The processor 206 may be coupled to the first memory and to the second memory. For instance, the processor 206 may be coupled to the first memory and the second memory with an interface, wire, bus, or a combination thereof. In some examples, the processor 206 may be coupled to the first memory and the second memory with a serial peripheral interface (e.g., SPI or eSPI) bus. For instance, the electronic device 202 may include a serial peripheral interface bus, where the processor 206 may access the first memory via the serial peripheral interface bus, may access the second memory via the serial peripheral interface bus, or may perform a combination thereof.

In some examples, the OS 204 includes an OS certificate store 210. For instance, the OS certificate store 210 may be stored in the first memory with OS instructions. In some examples, the OS certificate store 210 may be included in a registry of the OS 204. In some examples, the OS certificate store 210 may include one or multiple certificate stores. For instance, the OS certificate store 210 may include a directory-level store, a device-level store, a service-level store, a user-level store, or a combination thereof. In some examples, the OS certificate store 210 may include all permanent or semi-permanent certificate store(s) (e.g., non-temporary certificate store(s)) included in the OS 204. Examples of certificate stores that may be included in the OS certificate store 210 may include “AddressBook,” “AuthRoot,” “CertificateAuthority,” “My,” “Root,” “TrustedPeople,” and “TrustedPublisher,” etc. The OS 204 may natively trust content with signatures, certificates, or a combination thereof, that can be successfully verified based on a certificate(s) in the OS certificate store 210. In some examples, any certificate that is not stored in the OS certificate store 210 may be a foreign certificate, and not natively trusted by the OS 204.

In some examples, the processor 206 may load a certificate (e.g., foreign certificate) from the BIOS 208. The OS certificate store 210 may be bypassed during the loading of the certificate. For instance, the certificate loaded from the BIOS 208 may be excluded from (e.g., not stored, not written to, etc.) the OS certificate store 210.

In some examples, the processor 206 may load the certificate from the BIOS 208 in response to determining that the signed instructions failed a verification based on the OS certificate store 210. For, instance, the processor 206 may perform a first verification on the signed instructions using the certificate(s) in the OS certificate store 210. In a case that the first verification fails, the processor 206 may load the certificate (e.g., foreign certificate) from the BIOS 208 to perform a second verification (e.g., foreign certificate verification 207).

In some examples, the processor 206 may execute a program 212 in the OS 204 to verify signed instructions based on the certificate (e.g., foreign certificate from the BIOS 208). For instance, the processor 206 may perform a foreign certificate verification 207 using a foreign certificate from the BIOS 208. In some examples, the signed instructions may be a driver. In some examples, the signed instructions may be firmware. For instance, the signed instructions may be a signed portable executable (PE) image, signed common object file format (COFF) image, signed option ROM (OpROM), etc.

In some examples, the verification (e.g., foreign certificate verification 207) may be performed as described in FIG. 1. For instance, the program 212 may be executed to decrypt a signature of a certificate included with the signed instructions (using a public key of the foreign certificate, for instance) to produce a first hash, to hash content (e.g., an executable portion of the signed instructions) to produce a second hash, and to compare the first hash and the second hash to determine whether a verification is successful or a failure.

In some examples, the processor 206 may instantiate an object (e.g., verification object) to perform the verification of the signed instructions. In some examples, the certificate (e.g., foreign certificate from the BIOS 208) is loaded into the object of the program 212. The object may be executed by the processor 206 to perform the verification. In a case that verification is successful, the electronic device 202 (e.g., processor 206) may report the successful verification, report the foreign certificate(s) used to produce the successful verification, install the signed instructions, execute the signed instructions, or a combination thereof.

In some examples, the signed instructions become untrusted when the object expires. The object (e.g., object instance) may expire when verification is complete, when the object goes out of scope, when the object is disposed from memory, or a combination thereof. For instance, the verification or trust of the signed instructions, within the context of the object, may expire when the object expires. In some examples, the signed instructions become untrusted when a verification session expires. For instance, a verification session may endure until verification (e.g., successful or failed verification) of the signed instructions is determined using a foreign certificate(s). In some examples, a verification session may endure while a set of signed instructions (e.g., drivers, firmware, etc.) are verified using a foreign certificate(s). In some examples, the verification or trust of the signed instructions, within the context of the verification session, may expire when the verification session expires. In some examples, the signed instructions may become untrusted in the context of the process within which the verification succeeds. If the trusted certificate pointed to by the verification is a foreign certificate, the signed instructions may be untrusted by the OS before, during, and after the verification in some examples. For instance, instructions signed by a foreign entity may be untrusted by the OS 204.

In some examples, the program 212 (e.g., process or object within a process) may trust or simulate trust of a foreign certificate. In some examples, the processor 206 (e.g., program 212) may produce a report based on the verification. In some examples, the report may indicate that the foreign certificate authorizes the verification. In a case that the verification is successful, the electronic device 202 (e.g., processor 206) may perform an operation in response to the successful verification. For instance, the processor 206 (e.g., program 212) may direct the OS 204 to trust the signed instructions based on the foreign authorization. In some examples, the trust may be a single-use trust in a case where the OS 204 is directed to trust the signed instructions. For instance, another trust verification or verifications that occur before, during, or after this process may be unaffected by the foreign certificate. In some examples, the processor 206 (e.g., program 212) may produce a report for presentation (e.g., display, communication, etc.) to a user or administrator indicating the result of the foreign verification of signed instructions. The results may indicate whether signed instructions have a verification issue for an environment (e.g., BIOS).

In some examples of the techniques described herein, a foreign certificate or certificate authority may be consumed by a verifying program 212 without adding any foreign security credential or certificate to the OS certificate store 210. In some examples, the program 212 logic may apply the trust of the foreign certificate(s) to a single signature verification session or to a lifetime of a single object that executes within the object's scope. Once the verification session or object lifetime expires, the foreign certificate(s) may be untrusted. Some examples of the techniques described herein may reduce security risk, impacting native verification, or a combination thereof. For instance, the trust based on the foreign certificate(s) may be limited to the program 212, object, or a combination thereof, because the OS certificate store 210 is not modified.

In some examples, the program 212 may provide a certificate-based signature verification scheme. In some examples, a certificate may be part of a chain of trust (e.g., trust hierarchy) of the OS certificate store 210. For instance, a first verification may be attempted using the OS certificate store 210, within which a chain of trust may apply. In some examples, a chain of trust (e.g., trust hierarchy) may root to a foreign certificate authority that has been imported into a verification session or object for a single use, to which the foreign certificate may apply in the chain of trust. In some examples, the processor 206 may execute the program 212 (during a verification session, with an object, or a combination thereof, for instance), to perform verification for each certificate in a chain of trust up to the trusted certificate (e.g., root certificate). When the root certificate is trusted, and all other signature verification cryptographic operations succeed, for example, then the signature verification may succeed within the context of the verifying entity (e.g., verification session, object, or a combination thereof). Because the OS certificate store 210 is not modified in some examples, the native signature verification security model is not modified. For instance, the foreign certificate may generally be untrusted by the OS 204. Trust of the foreign certificate may be confined to the program 212. Once the single-use verification session, object scope, or a combination thereof expires, for instance, trust of the foreign certificate(s) may expire. In some examples, the foreign certificate may be imported again to be trusted again. If the foreign certificate(s) is imported, for example, the foreign certificate(s) may be applied for a single verification session without modifying the OS certificate store 210 or producing side effects for the native security trust model.

In some examples, the electronic device 202 may perform one, some, or all of the aspects, operations, elements, etc., described in one, some, or all of FIG. 1-5. In some examples, the electronic device 202 may include an element described in one, some, or all of FIG. 1-5.

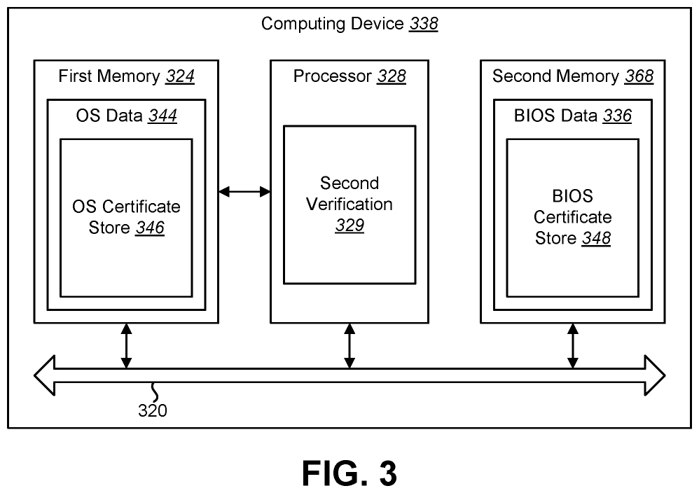

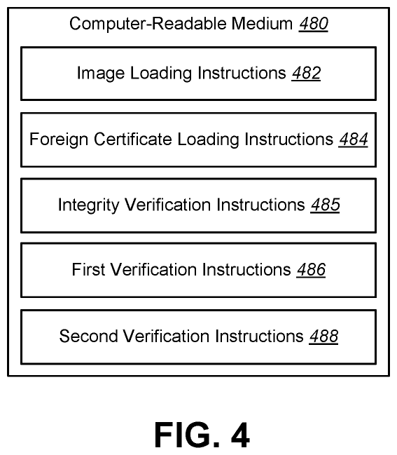

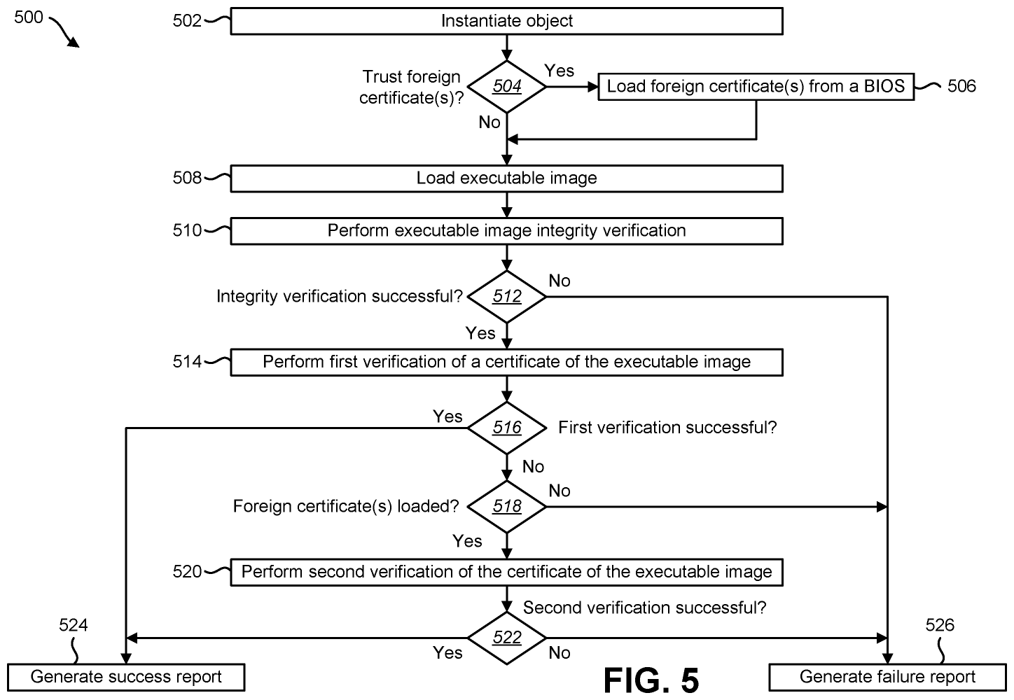

FIG. 3 is a block diagram illustrating an example of a computing device 338 to perform instruction verifications. In some examples, the computing device 338 may perform the operations described in FIG. 1, FIG. 2, FIG. 4, FIG. 5 or a combination thereof. The computing device 338 may be an example of the electronic device 202 described in FIG. 2. In some examples, the computing device 338 may include processor 328, a first memory 324, a second memory 368, and a bus 320.

Examples of the computing device 338 may include a computing device, smartphone, laptop computer, tablet device, mobile device, etc. In some examples, one, some, or all of the components of the computing device 338 may be structured in hardware (e.g., circuitry). In some examples, the components described in FIG. 3 may be examples of corresponding components described in FIG. 1, FIG. 2, or a combination thereof. In some examples, the computing device 338 may perform one, some, or all of the operations described in FIG. 1-5.

In some examples, the processor 328, first memory 324, and second memory 368 may be coupled to the bus 320. Examples of the bus 320 may include an SPI bus, eSPI bus, inter-integrated circuit (I2C) bus, general purpose input/output (GPIO) bus, or a combination thereof, etc. The bus 320 may be utilized to communicate a signal, information, or a combination thereof. In some examples, the electronic device 202 may include a coupling(s) in addition to the bus 320. For instance, the processor 328 may be coupled to the first memory 324 independently of the bus 320.

Examples of the first memory 324 may include RAM, a hard disk drive (HDD), NVMe memory, or a combination thereof, etc. The first memory 324 may store OS data 344. OS data 344 may include information, instructions, or a combination thereof to provide an OS for the computing device 338. For instance, the computing device 338 may include an OS. In some examples of FIG. 3, an “OS” may refer to the processor 328 executing instructions in the OS data 344 to perform an operation(s).

In some examples, the OS data 344 may include an OS certificate store 346. The OS certificate store 346 may include certificates that are trusted by the OS.

Examples of the second memory 368 may include ROM, EPROM, EEPROM, flash memory, or a combination thereof, etc. The second memory 368 may store BIOS data 336. BIOS data 336 may include information, instructions, or a combination thereof to provide a BIOS for the computing device 338. For instance, the computing device 338 may include a BIOS. In some examples of FIG. 3, a “BIOS” may refer to the processor 328 executing instructions in the BIOS data 336 to perform an operation(s). In some examples, some or all BIOS data 336 may be stored in (e.g., accessed from) an external device. For instance, some or all BIOS data 336 (e.g., executable code) may be accessed from a disk device, Universal Serial Bus (USB) flash device, multimedia device (e.g., eMMC or other), network device (e.g., LAN device, Internet server, etc.), or other storage device.

In some examples, the BIOS data 336 may include a BIOS certificate store 348. The BIOS certificate store 348 may include certificates that are trusted by the BIOS. In some examples, the BIOS certificate store 348 may include a certificate separate from the OS certificate store 346. For instance, the BIOS certificate store 348 may include a certificate that is not included in the OS certificate store 346, and therefore is natively untrusted by the OS.

In some examples, the processor 328 may perform a first verification of signed instructions. For instance, the processor 328 may load signed instructions into the first memory 324. For instance, the computing device 338 may receive the signed instructions from an external storage device (e.g., thumb drive), via a network (e.g., the Internet), or a combination thereof. The signed instructions may include a certificate (e.g., public key, issuer identity, and signature, etc.). In some examples, the signed instructions may be a signed executable image. Examples of the signed instructions may include firmware, a driver, PE image, COFF image, OpROM, etc. For instance, the signed instructions may be a firmware update, a driver, boot instructions, or a combination thereof to be executed in a BIOS. In some examples, the processor 328 may execute a program (e.g., verification program) to perform the first verification.

In some examples, the processor 328 may produce a failure determination that a first verification (e.g., issuer verification) of the signed instructions based on the OS certificate store 346. For instance, the processor 328 may determine that the signed instructions (e.g., the certificate, issuer identity, signature, etc.) failed verification because the OS certificate store 346 did not include a trusted certificate to verify the signed instructions. In some examples, the first verification (e.g., issuer verification) may be performed as described in FIG. 1, FIG. 2, or a combination thereof.

In some examples, the processor 328 may load a certificate from the BIOS certificate store 348. For instance, the processor 328 may load a certificate that is not included in the OS certificate store 346 from the BIOS certificate store 348 into the first memory 324. In some examples, the certificate from the BIOS certificate store 348 is not included in the OS certificate store 346. In some examples, the certificate from the BIOS certificate store 348 may be loaded without modifying the OS certificate store 346.

In some examples, the processor 328 may produce a second verification 329 based on the certificate in response to the failure determination. For instance, the processor 328 may perform a second verification 329 (e.g., issuer verification) based on the certificate from the BIOS certificate store 348. In some examples, the second verification 329 (e.g., issuer verification) may be performed as described in FIG. 1, FIG. 2, or a combination thereof.

In a case that the second verification 329 is successful, the processor 328 may produce a report indicating verification success. In a case that the second verification 329 is unsuccessful, the processor 328 may produce a report indicating verification failure. The computing device 338 may output the report. For instance, the computing device 338 may display the results of the second verification 329 on a display device or display panel (e.g., monitor, touchscreen, television, etc.). In some examples, the computing device 338 may send the report to another device. For instance, the computing device 338 may include a communication interface (not shown in FIG. 3) that may be utilized to send the report to a remote computing device (e.g., server, desktop computer, tablet, smartphone, etc.).

In some examples, the processor 328 may produce the second verification 329 based on an instance of a verification object. For instance, the processor 328 may execute a program to instantiate a verification object in the first memory 324. In some examples, the processor 328 may load the certificate from the BIOS certificate store 348 into the verification object. In some examples, the second verification 329 may expire with the instance of the verification object. For instance, when the second verification 329 is complete, when the verification object is longer being used (e.g., is disposed from the first memory), the second verification 329 may expire. For example, the signed instructions may be untrusted when the second verification 329 expires.

FIG. 4 is a block diagram illustrating an example of a computer-readable medium 480 for instruction verification. The computer-readable medium 480 is a non-transitory, tangible computer-readable medium. In some examples, the computer-readable medium 480 may be, for example, RAM, DRAM, EEPROM, MRAM, PCRAM, a storage device, an optical disc, the like, or a combination thereof. In some examples, the computer-readable medium 480 may be volatile memory, non-volatile memory, or a combination thereof. In some examples, the computer-readable medium 480 described in FIG. 4 may be an example of memory including instructions to be executed by a processor to verify signed instructions. For instance, the computer-readable medium 480 may be an example of the first memory 324 described in FIG. 3. In some examples, the computer-readable medium 480 may be separate from a second memory 368.

The computer-readable medium 480 may include data (e.g., information, instructions). In the example of FIG. 4, the computer-readable medium 480 includes image loading instructions 482, foreign certificate loading instructions 484, integrity verification instructions 485, first verification instructions 486, and second verification instructions 488.

The image loading instructions 482 may include instructions that when executed cause a processor of an electronic device to load an executable image (e.g., firmware, PE image, COFF image, OpROM, etc.). For instance, the executable image may be a driver, firmware, or a combination thereof. In some examples, loading the executable image may be performed as described in FIG. 1, FIG. 2, FIG. 3, FIG. 5, or a combination thereof.

The foreign certificate loading instructions 484 may include instructions that when executed cause the processor to load a foreign certificate. In some examples, the foreign certificate may be loaded from an authentication authority. In some examples, the foreign certificate may be loaded from a BIOS. In some examples, the foreign certificate may be received, loaded, or a combination thereof from another device. For instance, the foreign certificate may be received from a server or external storage. For instance, the foreign certificate may be provided from a third-party security authority (e.g., a vendor that supplies OpROMs for consumption by a BIOS). In some examples, the verification procedure(s) described herein may be utilized to determine whether an executable image (e.g., PE image, OpROM, etc.) can be verified in accord with the trust of the third-party's OS environment, where the third-party OS environment may be different from the local OS environment, or may be different from the BIOS environment. For instance, some of the techniques described herein may be utilized to perform verification in a local device (e.g., electronic device 202, computing device 338, etc.) as verification would be performed in a foreign environment from which a credential is delivered. In some examples, loading the foreign certificate may be performed as described in FIG. 1, FIG. 2, FIG. 3, FIG. 5, or a combination thereof. In some examples, the foreign certificate is excluded from an OS certificate store.

The integrity verification instructions 485 may include instructions that when executed cause a processor of an electronic device to verify executable image integrity. For instance, the processor may decrypt a signature of the executable image using a public key that accompanies the executable image to produce a first hash. The processor may hash the executable image (e.g., the executable portions of the executable image) to produce a second hash. In a case that the first hash and the second hash match, the processor may determine a successful verification of the executable image integrity. In a case that the first hash and the second hash do not match, the processor may determine an unsuccessful verification of the executable image integrity.

The first verification instructions 486 may include instructions that when executed cause the processor to perform a first verification (e.g., issuer verification) on the executable image (e.g., certificate of the executable image). In some examples, verifying the executable image may be performed as described in FIG. 1, FIG. 2, FIG. 3, FIG. 5, or a combination thereof. For instance, the processor may perform an issuer verification based on an OS certificate store. In some examples, the processor may produce a failure determination of the first verification of the certificate of the executable image based on the OS certificate store. In some examples, the OS certificate store includes a directory-level store, a device-level store, a service-level store, a user-level store, or a combination thereof.

The second verification instructions 488 may include instructions that when executed cause the processor to perform a second verification (e.g., issuer verification) on the executable image (e.g., certificate of the executable image). In some examples, verifying the executable image may be performed as described in FIG. 1, FIG. 2, FIG. 3, FIG. 5, or a combination thereof. For instance, the processor may perform a second verification (e.g., issuer verification) of the certificate based on the foreign certificate in response to the failure determination. In some examples, the processor may produce a failure determination or a successful determination of the second verification of the certificate of the executable image based on the foreign certificate.

In some examples, the image loading instructions 482, the foreign certificate loading instructions 484, the integrity verification instructions 485, the first verification instructions 486, the second verification instructions 488, or a combination thereof, may be included in a program to verify an executable image. For instance, the foreign certificate loading instructions 484 and the second verification instructions 488 may be included in the program. In some examples, the processor may execute the program to instantiate an object. The second verification may be performed using the object. In some examples, the certificate is loaded into the object, and the executable image becomes untrusted when the object expires. In some examples, the executable image becomes untrusted when a verification session expires.

FIG. 5 is a flow diagram illustrating an example of a method 500 for instruction verification. The method 500 or a method 500 element may be performed by an electronic device, computing device, or apparatus (e.g., electronic device 202, computing device 338, laptop computer, smartphone, tablet device, smartphone, etc.). For example, the method 500 may be performed by the electronic device 202 described in FIG. 2 or the computing device 338 described in FIG. 3.

At step 502, an electronic device may instantiate an object. For instance, a processor may execute a program to instantiate an object to verify an executable image (e.g., signed instructions, PE image, COFF image, firmware, driver, etc.). In some examples, the object instance may be temporarily stored in RAM. In some examples, the object instance may include a function to perform integrity verification, a function to perform issuer verification, a function to perform hashing, a function to compare hashes, or a combination thereof. In some examples, the object instance may include a variable(s) to hold data (e.g., signature(s), hash(es), issuer identity(ies), etc.).

At step 504, the electronic device may determine whether to trust a foreign certificate. For example, the electronic device may receive or store an indicator from an interface (e.g., user interface, keyboard, touchscreen, communication interface, etc.) indicating whether to trust a foreign certificate. The electronic device may determine whether to trust a foreign certificate as indicated by the indicator. In a case that it is determined to not trust a foreign certificate, the electronic device may proceed to load an executable image at step 508.

In a case that it is determined to trust a foreign certificate, the electronic device may load a foreign certificate from a BIOS at step 506. In some examples, loading a foreign certificate may be accomplished as described in FIG. 1, FIG. 2, FIG. 3, FIG. 4, or a combination thereof.

At step 508, the electronic device may load an executable image. In some examples, loading an executable image may be accomplished as described in FIG. 1, FIG. 2, FIG. 3, FIG. 4, or a combination thereof.

At step 510, the electronic device may perform executable image integrity verification. In some examples, performing executable image integrity verification may be performed as described herein. For instance, the electronic device (e.g., object instance) may decrypt a signature accompanying the executable image using a public key accompanying the executable image to produce a first hash, may hash content of the executable image to produce a second hash, and may compare the first hash and second hash to verify the executable image integrity.

At step 512, the electronic device may determine whether the integrity verification is successful. For instance, if the first hash matches the second hash, then the integrity verification is successful. If first hash does not match the second hash, then the integrity verification is unsuccessful (e.g., a failure). In a case that the integrity verification is unsuccessful, the electronic device may generate a failure report at step 526. The failure report may be a document, image, text, message, etc., or combination thereof indicating that the executable image integrity verification was unsuccessful (e.g., indicating that the executable image has been modified).

In a case that the integrity verification is successful, the electronic device may perform a first verification (e.g., issuer verification) of a certificate of the executable image at step 514. In some examples, performing the first verification may be accomplished as described in FIG. 1, FIG. 2, FIG. 3, FIG. 4, or a combination thereof. For instance, the electronic device may perform the first verification based on a certificate(s) from the OS certificate store.

At step 516, the electronic device may determine whether the first verification is successful. For instance, if the hashes produced in the first verification match, then the first verification is successful. If the hashes produced in the first verification do not match, then the first verification is unsuccessful (e.g., a failure). In a case that the first verification is successful, the electronic device may generate a success report at step 524. The success report may be a document, image, text, message, etc., or combination thereof indicating that the first verification (e.g., verification based on the OS certificate store) was successful (e.g., indicating that the executable image is trusted).

In a case that the first verification is unsuccessful, the electronic device may determine whether a foreign certificate is loaded at step 518. For instance, the electronic device may determine whether a foreign certificate was loaded at step 506. In a case that a foreign certificate is not loaded, the electronic device may generate a failure report at step 526.

In a case that a foreign certificate is loaded, the electronic device may perform a second verification (e.g., issuer verification) of the certificate of the executable image at step 520. In some examples, performing the second verification may be accomplished as described in FIG. 1, FIG. 2, FIG. 3, FIG. 4, or a combination thereof. For instance, the electronic device may perform the second verification based on a foreign certificate(s) from the BIOS.

At step 522, the electronic device may determine whether the second verification is successful. For instance, if the hashes produced in the second verification match, then the second verification is successful. If the hashes produced in the second verification do not match, then the second verification is unsuccessful (e.g., a failure). In a case that the second verification is successful, the electronic device may generate a success report at step 524. The success report may be a document, image, text, message, etc., or combination thereof indicating that the second verification (e.g., verification based on the foreign certificate(s)) was successful (e.g., indicating that the executable image is trusted). In a case that the second verification is unsuccessful, the electronic device may generate a failure report at step 526.

Some examples of the techniques described herein may be performed to provide an indication of BIOS functioning. For instance, some examples of the techniques may be utilized to indicate what instructions (e.g., firmware, PE image(s), COFF image(s), OpROM(s), etc.) are executed (or are to be executed) in a pre-boot environment. Some examples of the techniques may indicate whether a BIOS trusts a certificate issuer of an executable image. For instance, an indication of the instructions for a pre-boot environment, an indicate of BIOS trust, of a combination thereof may be provided in a success report or a failure report. Some examples of the techniques described herein may provide a report of BIOS-level trust without changing the security model (e.g., OS certificate store) of the OS.

Some examples of the techniques described herein may provide evaluation of firmware. For instance, an entity (e.g., business) may submit firmware (e.g., OpROM, driver, PE image, COFF image, etc.) for execution in a BIOS. Some examples of the techniques described herein may be utilized to determine whether the firmware is signed by the entity (e.g., issuer). For instance, firmware may be evaluated for trust before deployment, installation, execution, or a combination thereof.

Some examples of the techniques described herein may provide a simulation of foreign trust. For instance, a device (e.g., electronic device 202, computing device 338, etc.) may determine how an entity (e.g., BIOS) would evaluate a signature on an item (e.g., PE image). In the simulation, a foreign certificate may be generally untrusted by an OS. In some examples, a foreign certificate may be untrusted by a process (e.g., program) performing the simulation, where the process may provide a report of verification results as they would be within the scope of a foreign environment (e.g., BIOS). For instance, the simulation may be performed to produce a report. In some examples, the OS and the process (e.g., program) may take no action based on the outcome (e.g., report). In some examples, the trust may be confined to the report. In some examples, a program (e.g., OS tool) may be provided to indicate how a foreign entity would evaluate trust based on a foreign certificate. In some examples, a report may be provided (e.g., displayed to, printed for, etc.) an end user or administrator.

In some examples of the techniques described herein, a certificate or certificates may be evaluated to perform executable instruction (e.g., executable image) integrity verification, to perform issuer verification of executable instructions, or a combination thereof, independent of (e.g., without) securing a communication channel (e.g., encrypting an network or Internet connection), independent of (e.g., without) authenticating a user, independent of (e.g., without) performing single sign-on, or a combination thereof. For instance, some examples of the certificates described herein may be excluded from a transport layer security (TLS) protocol, from a secure socket layer (SSL) protocol, from a user authentication protocol, or a combination thereof.

As used herein, items described with the term “or a combination thereof” may mean an item or items. For example, the phrase “A, B, C, or a combination thereof” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operation(s), function(s), aspect(s), or element(s) of the examples described herein may be omitted or combined.

What is claimed is:

1. An electronic device, comprising:
an operating system (OS);
a basic input/output system (BIOS);
an OS certificate store; and
a processor to:
load a certificate from the BIOS, wherein the OS certificate store is bypassed during the loading of the certificate; and
execute a program in the OS to verify signed instructions based on the certificate.

2. The electronic device of claim 1, wherein the OS certificate store comprises a directory-level store, a device-level store, a service-level store, and a user-level store.

3. The electronic device of claim 1, wherein the certificate is loaded into an object of the program.

4. The electronic device of claim 3, wherein the signed instructions become untrusted when the object expires.

5. The electronic device of claim 1, wherein the signed instructions become untrusted when a verification session expires.

6. The electronic device of claim 1, wherein the signed instructions are a driver.

7. The electronic device of claim 1, wherein the signed instructions are firmware.

8. The electronic device of claim 1, wherein the processor is to load the certificate from the BIOS in response to determining that the signed instructions failed a verification based on the OS certificate store.

9. A computing device, comprising:
an operating system (OS);
an OS certificate store;
a basic input/output system (BIOS);
a BIOS certificate store comprising a certificate separate from the OS certificate store; and
a processor to:
produce a failure determination of a first verification of signed instructions based on the OS certificate store;
load the certificate from the BIOS certificate store; and
produce a second verification based on the certificate in response to the failure determination.

10. The computing device of claim 9, wherein the processor is to produce the second verification based on an instance of a verification object.

11. The computing device of claim 10, wherein the second verification expires with the instance of the verification object.

12. The computing device of claim 9, wherein the signed instructions are a signed executable image.

13. A non-transitory tangible computer-readable medium comprising instructions when executed cause a processor of an electronic device to:
load an executable image;
load a foreign certificate;
verify executable image integrity;
produce a failure determination of a first verification of a certificate of the executable image based on an operating system (OS) certificate store; and
produce a second verification of the certificate based on the foreign certificate in response to the failure determination.

14. The non-transitory tangible computer-readable medium of claim 13, wherein the instructions when executed cause the processor to instantiate an object, wherein the second verification is performed using the object.

15. The non-transitory tangible computer-readable medium of claim 14, wherein the foreign certificate is excluded from the OS certificate store.

16. The non-transitory tangible computer-readable medium of claim 13, wherein the OS certificate store comprises a directory-level store, a device-level store, a service-level store, and a user-level store.

17. The non-transitory tangible computer-readable medium of claim 13, wherein the certificate is loaded into an object, and wherein the executable image becomes untrusted when the object expires.

18. The non-transitory tangible computer-readable medium of claim 13, wherein the executable image becomes untrusted when a verification session expires.

19. The non-transitory tangible computer-readable medium of claim 13, wherein the executable image is a driver.

20. The non-transitory tangible computer-readable medium of claim 13, wherein the executable image is firmware.
